(19) United States
(12) Patent Application Publication
(10) Pub. No.: US 2003/0074361 A1
(43) Pub. Date: Apr. 17, 2003

(54) Database and information system arrangement for use in designing an architecture for a warfare mission

(75) Inventors: Rebecca Ferris, Panama City Beach, FL (US); Tracy Nye, Panama City Beach, FL (US); Melissa Lassalle, Panama City Beach, FL (US)

Correspondence Address: COASTAL SYSTEMS STATION, DAHLGREEN DIVISION, NAVAL SURFACE WARFARE CENTER, 6703 W HWY 98 CODE CP2L, PANAMA CITY, FL, 32407-7001, US

(73) Assignee: The United States of America represented by the Secretary of the Navy

(21) Appl. No.: 09/981,360

(22) Filed: Oct. 15, 2001

(51) Int. Cl. G06F 17/00

(52) U.S. Cl. 707/100

(57) ABSTRACT

The present invention provides a database and information system arrangement for use in designing an operational architecture for a warfare mission. An operational process section describes information related to operational activities of the warfare mission. A data section identifies input data used by the operational activities and output data resulting from the operational activities. An organizational section identifies an organizational hierarchy and assets used to carry out the operational activities and identifies storage locations for the input data and the output data.

### ORIGIN OF THE INVENTION

The invention described herein was made in the performance of official duties by employees of the Department of the Navy and may be manufactured, used, licensed by or for the Government for any governmental purpose without payment of any royalties thereon.

### FIELD OF THE INVENTION

The invention relates generally to database arrangements, and more particularly to a database and information system arrangement for use in designing an architecture for a specific warfare mission such as mine warfare, littoral warfare, amphibious warfare, etc.

### BACKGROUND OF THE INVENTION

The U.S. military has been challenged by the Joint Chiefs of Staff to transform itself into a preeminent joint force that is completely interoperable. This interoperability must occur from warfighter to warfighter, from warfighter to command, from command to command, from military branch to military branch—all the way to government agencies and our country's multinational partners. While an amazing array of sophisticated technological tools exist that can help make this interoperability a reality, the challenge is how to use these tools to operationally link every person and every system. One of the keys to meeting this challenge lies in the design of military “command, control, communications, computers, intelligence, surveillance and reconnaissance” (or “C4ISR” as it is known) architectures.

The design of a C4ISR architecture must meet the assigned requirements while simultaneously being compatible with and comparable to other C4ISR architectures throughout the joint force. In designing such an architecture, the C4ISR Architecture Framework can be used. This framework is not a blueprint for developing an architecture, but rather offers guidance for describing architectures in a standardized way that is crucial to successful warfare-area C4ISR architecture development. The C4ISR Architecture Framework, Version 2.0, was developed by the C4ISR Architecture Working Group, and can be downloaded from the internet at

http://www.c3i.osd.mil/org/cio/i3/AWG Digital Library/.

Briefly, the C4ISR Architecture Framework was developed to ensure that architectures developed by the geographic and functional commands, services and agencies can:

1) be interrelated between and among the organizations' operational, systems, and technical architecture views, and

2) be comparable and compatible across joint and multinational organizational boundaries.

It is important to understand that the framework provides direction on how to describe architectures, and not how to design or implement a specific architecture, or how to develop and acquire systems-of-systems. The framework draws a very clear distinction between architecture description and architecture implementation. It defines an architecture description as a “representation, as of a current or future point in time, of a defined ‘domain’ in terms of its component parts, what those parts do, how the parts relate to each other, and the rules and constraints under which the parts function.”

The framework is currently directed at C4ISR architectures with the focus on C4ISR support to the warfighter. The C4ISR Architecture Framework contains four main types of guidance for developing an architecture as follows:

1) Guidelines, which include a set of guiding principles for building architectures, that comply with the framework.

2) A high-level process for using the framework to build and integrate architectures.

3) A discussion of architecture data and tools that can facilitate the architecture-description process.

4) A detailed description of the product types.

The framework describes three different perspectives or “views” that logically combine to describe a C4ISR architecture. These views are the operational, systems, and technical views. Each of the three views affects which architecture characteristics are to be considered and/or displayed. Each view provides a different perspective on the same architecture. The framework's description of the different views will be presented briefly below.

The operational view provides a description of the tasks and activities, operational elements, and information flows required to accomplish or support a military operation. It contains descriptions (often graphical) of the operational elements, assigned tasks and activities, and information flows required to support the warfighter. It defines the types of information exchanged, the frequency of exchange, which tasks and activities are supported by the information exchanges, and the nature of information exchanges in detail sufficient to ascertain specific interoperability requirements.

The systems view describes systems and interconnections providing for or supporting warfighting functions. For a domain, the systems architecture view shows how multiple systems link and interoperate, and may describe the internal construction and operations of particular systems within the architecture. For an individual system, the systems architecture view includes the physical connection, location, and identification of key nodes (including material item nodes), circuits, networks, warfighting platforms, etc., and specifies system and component performance parameters (e.g., mean time between failure, maintainability, availability). The systems architecture view associates physical resources and their performance attributes to the operational view and its requirements per standards defined in the technical architecture.

The technical view describes the minimal set of rules governing the arrangement, interaction, and interdependence of system parts or elements, whose purpose is to ensure that a conformant system satisfies a specified set of requirements. The technical architecture view provides the technical systems implementation guidelines upon which engineering specifications are based, common building blocks are established, and product lines are developed. The technical architecture view includes a collection of the technical standards, conventions, rules and criteria organized into profile(s) that govern system services, interfaces, and relationships for particular systems architecture views and that relate to particular operational views.

As noted previously, the C4ISR Architecture Framework provides direction on how to describe architectures, but not how to design or implement a specific architecture. This poses a great challenge. Since the three views (operational, systems, and technical) and their products are new constructs, they are not supported by existing systems engineering formalisms or tools. Further, each product contains a great deal of information. Accordingly, designing a C4ISR architecture is a highly complex task, particularly when the design must be comparable to other architectures. While the C4ISR Architecture Framework is a very useful tool, using it effectively and efficiently is a challenge in itself. To handle the complex nature of the C4ISR architecture design, it is necessary to develop supporting tools and processes to help facilitate the architecture design process. In particular, with respect to the architecture's operational view, it is necessary to provide the means to deal with the myriad of data and organizational relationships involved in the operational view.

### SUMMARY OF THE INVENTION

Accordingly, it is an object of the present invention to provide a system that can be used as a tool in the design of an architecture for a warfare area or mission.

Another object of the present invention is to provide a system for facilitating the handling of data and organizational relationships used by a warfare area or mission.

Still another object of the present invention is to provide a system for storing information used to describe the operational view of an architecture for a warfare area or mission.

Other objects and advantages of the present invention will become more obvious hereinafter in the specification and drawings.

In accordance with the present invention, a database and information system arrangement are provided. Specifically, the arrangement is useful in designing an operational architecture for warfare missions such as mine warfare, littoral warfare, amphibious warfare, etc. The data and organizational relationships are provided in a format that is useful for designing the operational view of a C4ISR architecture. The arrangement can be applied to any warfare area's operational view. In the arrangement, an operational process section describes: i) operational activities of the warfare mission, ii) a sequence for the operational activities, iii) problems associated with the operational activities, and iv) performance characterizations of the operational activities. A data section identifies input data used by the operational activities and output data resulting from the operational activities. An organizational section identifies an organizational hierarchy and assets used to carry out the operational activities and identifies storage locations for the input data and the output data.

### BRIEF DESCRIPTION OF THE DRAWINGS

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is a top-level functional block diagram illustrating the relationship of a database and information system arrangement of the present invention in relation to the design of a C4ISR architecture for a warfare area or mission; and

FIG. 2 is a database structure model for the database and information system arrangement of the present invention for use in designing an operational architecture for a warfare area or mission.

### DETAILED DESCRIPTION OF THE INVENTION

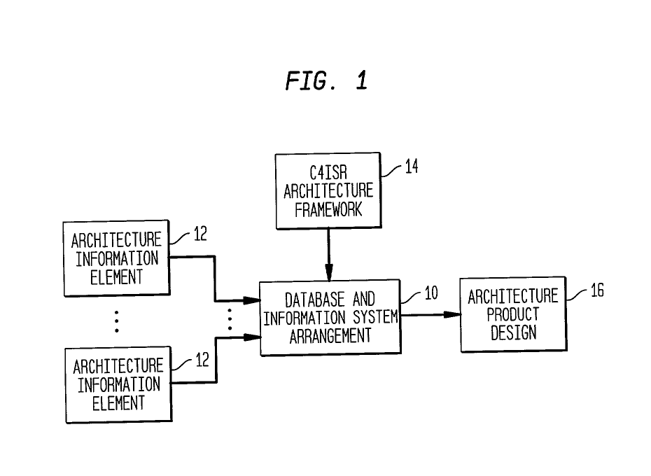

Referring now to the drawings, and more particularly to FIG. 1, a database and information system arrangement 10 is illustrated in relation to the design of a C4ISR architecture for a warfare area or mission. In the present invention, arrangement 10 provides the means to capture/store and organizational relationships used in the design of the operational view of a warfare mission's architecture. Such warfare missions include, but are not limited to, mine warfare, littoral warfare, amphibious warfare, ground warfare and air warfare.

In designing the operational view of a warfare mission's architecture, a large number of architecture information elements 12 must be assembled in a cohesive fashion such that the Department of Defense's C4ISR Architecture Framework 14 can be implemented during an architecture products design 16. Broadly speaking, architecture information elements 12 include various operational activities and the various organizations and assets used/needed to carry out the operational activities. The activities and organizations provide data and/or supply data to other activities/organizations. Accordingly, database and information system arrangement 10 defines a structure that organizes the operational activities, organizations and data utilized/created thereby in a format satisfying the criteria in C4ISR Architecture Framework 14.

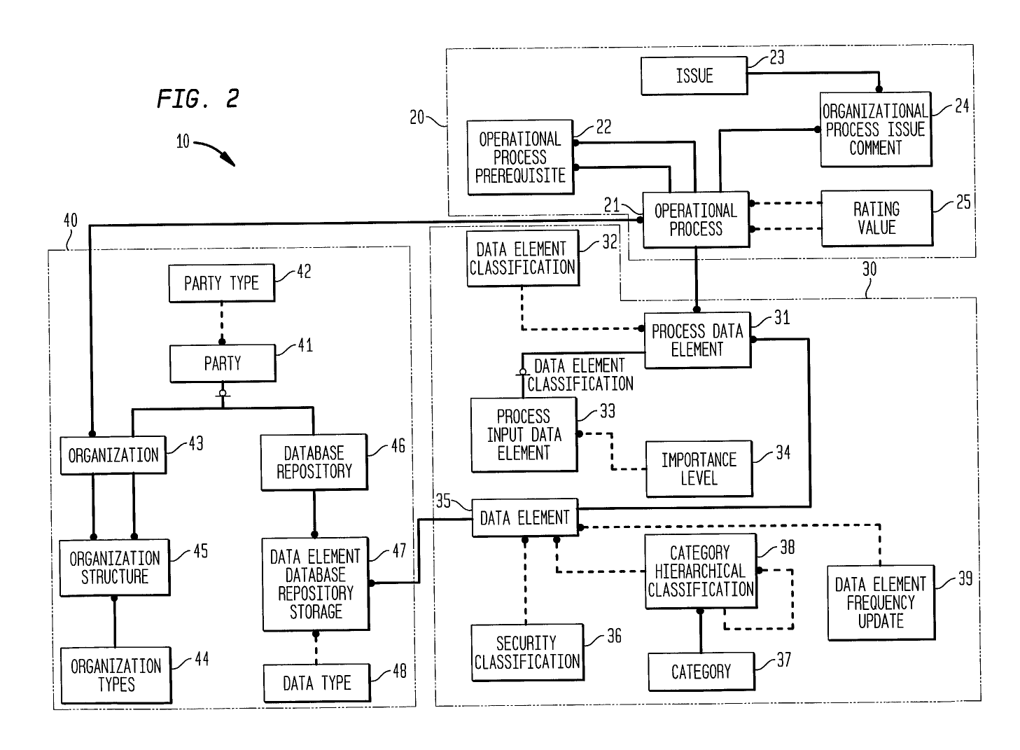

Referring now to FIG. 2, a database structure model for database and information system arrangement 10 is illustrated. The format of the model used to illustrate arrangement 10 is the well-known IDEF1X modeling standard which is described in detail in “Announcing the Standard for Integration Definition for Information Modeling (IDEF1X),” Federal Information Processing Standards Publication 184, December, 1993. Briefly, as is known in the art, a solid line in FIG. 2 depicts an identifying relationship between a high-level or parent entity and a sub-level or child entity. A dashed-line depicts a non-identifying relationship between parent and child entities. Network recursive relationships (i.e., those defining many-to-many relationships) are defined by the use of side-by-side solid or dashed lines depending on the nature of the particular relationship.

System arrangement 10 will be described in sections. However, it is to be understood that the order of explanation herein in no way defines or limits the order of data entry or flow in system arrangement 10. Section 20 defines an arrangement of database “buckets” for storing and handling information related to the operational activities of the warfare mission. Operational process section 21 contains information regarding all of the tasks, processes or activities conducted during the particular warfare mission's operations. This includes parent and child processes. Operational process prerequisite section 22 references the child processes that comprise a particular parent process. Also included is a description of the order or sequence for the execution of the operational activities listed and described in operational process section 21. An issue section 23 can be provided for the storage of issues or problems known to be associated with the operation activities listed and described in system 21. An operational process issue comment section 24 provides for storage of user-input comments related to a particular issue of an operational activity. A rating value section 25 can be provided for storage of characterizations of past performance of the various operational activities.

Section 30 defines an arrangement of database buckets for storing and handling information related to the data used by the various operational activities listed and described in operational process section 21. Process data element section 31 lists the types of data needed for all of the operational activities. Data element classification selection 32 identifies each type of data as being either input data used by the particular operational activity or output data resulting from the particular operational activity. Process input data element section 33 identifies the input data elements associated with a particular operational activity and importance level section 34 allows the user to assign a relative level of importance (e.g., high, medium, low, etc.) to each such data element.

Date element section 35 provides details about each data element listed in process data element section 31. Such details can include, but are not limited to, a security classification (e.g,. unclassified, confidential, secret, top secret, etc.) of each data element, category and hierarchy of each data element, and the frequency with which a data element changes or is updated. Security classifications are stored in section 36. Categories and hierarchal (i.e., parent/child relationships) relationships between categories are stored in sections 37 and 38, respectively. The frequency with which a data element changes are stored in section 39.

Section 40 defines an arrangement of database buckets for storing and handling information related to the organizations that carry out the various operational activities listed in operational process section 21. Party section 41 is a domain of all assets (i.e., organizations, groups of individual within a particular organization, and various other assets utilized by the operational activities such as messages, documents, reports, memos, etc.) that can perform tasks for the operational activities. Party type section 42 defines the type of each asset in section 41. Organization section 43 lists and describes all of the organizational groups associated with the operational activities in section 21. The type of each organization and hierarchal relationships between organizations are stored in sections 44 and 45, respectively.

Since the various data elements listed in section 35 are associated with a wide variety of systems, their execution/storage locations are also widely varied. Accordingly arrangement 10 includes a database repository section 46 that identifies the authoritative data repository listing while section 47 provides database repository assignments for data elements listed in section 35. The format of a data element in a repository is stored separately in section 48. The format of a data element could be, for example, an image, ASCII text, etc.

The advantages of the present invention are numerous. The database and information system arrangement provides data and organizational relationships in a format that is useful for designing the operational view of a C4ISR architecture. The arrangement can be applied to any warfare area's operational view and, therefore, provides for interoperability between different branches of the military.

Although the invention has been described relative to a specific embodiment thereof, there are numerous variations and modifications that will be readily apparent to those skilled in the art in light of the above teachings. It is therefore to be understood that, within the scope of the appended claims, the invention may be practiced other than as specifically described.

What is claimed as new and desired to be secured by Letters Patent of the United States is:

1. A database and information system arrangement for use in designing an architecture for a warfare mission, comprising:
a first section for storing information related to operational activities of said warfare mission;
a second section coupled to said first section for storing information related to data associated with said operational activities; and
a third section coupled to said first section and said second section for storing information related to organizations permitted to carry out said operational activities and for storing information related to storage locations for said data.

2. A database and information system as in claim 1 wherein said first section comprises:
a description section describing each of said operational activities;
a sequencing section describing a sequence for said operational activities; and
an issue section for storing information related to problems associated with said operational activities.

3. A database and information system as in claim 2 wherein said first section further comprises a rating section for storing performance characterizations of said operational activities.

4. A database and information system as in claim 1 wherein said second section comprises:
an identification section for identifying types of said data; and
a definition section for storing detail information related to each of said types of said data.

5. A database and information system as in claim 4 wherein said third section includes:
a listing section for storing a list of said organizations;
a hierarchal section for defining authoritative relationships within each of said organizations; and
an assignment section coupled to said definition section for identifying said storage locations for each of said types of said data.

6. A database and information system arrangement for use in designing an operational architecture for a warfare mission, comprising:
an operational process section describing operational activities of said warfare mission, a sequence for said operational activities, problems associated with said operational activities and performance characterizations of said operational activities;
a data section for identifying input data used by said operational activities and output data resulting from said operational activities; and
an organizational section for identifying an organizational hierarchy and assets used to carry out said operational activities and for identifying storage locations for said input data and said output data.

7. A database and information system as in claim 6 wherein said data section includes a data relationship section identifying relationships between said input data and said output data used by said operational activities.

8. A database and information system as in claim 7 wherein said data relationships section includes an importance section identifying relative importance of said input data and said output data used by said operational activities.

9. A database and information system as in claim 6 wherein said data section includes a detail section for defining security classifications, categorical classifications, categorical hierarchies and update information associated with said input data and said output data.
